(19) United States
(12) Patent Application Publication
(10) Pub. No.: US 2015/0354494 A1
(43) Pub. Date: Dec. 10, 2015

(54) CYLINDER HEAD AND ENGINE

(71) Applicant: MITSUBISHI HEAVY INDUSTRIES, LTD., Tokyo (JP)

(72) Inventors: Yuta Furukawa, Tokyo (JP); Kazuo Ogura, Tokyo (JP)

(73) Assignee: Mitsubishi Heavy Industries, Ltd., Tokyo (JP)

(21) Appl. No.: 14/760,987

(22) PCT Filed: Feb. 20, 2013
(86) PCT No.: PCT/JP2013/054173

§ 371 Date: Jul. 14, 2015

(51) Int. Cl. F02F 1/42

(52) U.S. Cl. CPC F02F 1/4285

(57) ABSTRACT

A cylinder head includes a cylinder head body provided with intake and exhaust ports opened toward a combustion chamber and capable of being closed by valves, the intake and exhaust ports being separated from each other in a circumferential direction around a cylinder central axis. An opening section of at least one of the intake or exhaust ports facing the combustion chamber is provided with a seat surface centered on a valve axis and a tapered surface is disposed closer to the combustion chamber than the seat surface, the tapered surface gradually increasing in diameter closer to the combustion chamber. A central axis of the tapered surface is disposed eccentrically from the valve axis toward the cylinder central axis.

### TECHNICAL FIELD

The present invention relates to a cylinder head and an engine including the same.

### BACKGROUND

A gas engine performing combustion operation using a gas fuel (fuel gas) such as natural gas or municipal gas is known as an exemplary engine. Such a gas engine can obtain high efficiency and high output, and thus is widely used for engines for continuous and emergency power generation, engines for construction machinery, engines mounted in ships, railroads, or the like.

In the gas engine, a fuel gas is supplied to air introduced from an intake pipe, and thereby a gas mixture composed of the air and the fuel gas is created. This gas mixture is compressed by a compressor of a supercharger, has its flow rate adjusted by a throttle valve, and then is supplied to a combustion chamber via an intake port. Then, the gas mixture is ignited in the combustion chamber, and thereby the combustion operation is performed. An exhaust gas is discharged via an exhaust port. Further, the intake port and the exhaust port are each formed in a cylinder head.

As the gas engine, a gas engine having a cylinder head equipped with an auxiliary chamber for ignition has been known (e.g., see Japanese Unexamined Patent Application, First Publication No. 2004-252213) In this gas engine, when a cylinder of a gas engine body approximates a top dead center for compression, a gas of the auxiliary chamber is ignited by sparks of a spark plug in the auxiliary chamber. Thereby, generated flames are ejected into a main combustion chamber, and a fuel-air mixture in the main combustion chamber is ignited. Thereby, the combustion operation is performed.

Here, a partial longitudinal sectional view of a gas engine 1 is shown in FIG. 4. A cylinder head 2 of the gas engine 1 is formed with an intake port 4 that is opened toward a combustion chamber 3. An opening 5 of the intake port 4 is formed with a seat surface 5a with which an outer circumferential surface of an intake valve 6 comes into contact. Also, a portion of the opening 5 of the intake port 4 wherein the portion is closer to the side of the combustion chamber 3, than the seat surface 5a, is formed with a tapered surface 5b that is increased in diameter toward the combustion chamber 3 in order to secure a flow coefficient.

### SUMMARY

In this gas engine 1, to greatly secure a diameter of intake valve 6, intake valve 6 is located immediately adjacent to the inside of an inner wall surface 8 of a cylinder block 7 defining combustion chamber 3. For this reason, an opening edge of tapered surface 5b located closer to the side of combustion chamber 3, than seat surface 5a, against which intake valve 6 abuts, is partly located at a radial outer side of inner wall surface 8 relative to inner wall surface 8 of the cylinder block 7.

For this reason, a part of an inner space of tapered surface 5b in opening 5 of intake port 4 becomes a separation space 9 separated from combustion chamber 3. Since flames of combustion chamber 3 are insufficient for separation space 9, there is a problem that a volume of separation space 9 does not contribute to combustion, which causes a reduction in combustion efficiency.

The present invention has been made in consideration of the above circumstances and an object of the present invention is to provide a cylinder head capable of improving combustion efficiency and an engine having the cylinder head.

The present invention employs the following:

That is, a cylinder head according to a first aspect includes: a cylinder head body provided with intake and exhaust ports opened toward a combustion chamber and is capable of being closed by valves, the intake and exhaust ports being separated from each other in a circumferential direction around a cylinder central axis; wherein an opening section of at least one of the intake or exhaust ports facing the combustion chamber is provided with a seat surface centered on a valve axis and a tapered surface disposed closer to the combustion chamber than the seat surface, the tapered surface gradually increasing in diameter closer to the combustion chamber, and a central axis of the tapered surface disposed eccentrically from the valve axis toward the cylinder central axis.

According to the cylinder head having this characteristic, since the central axis of the tapered surface is located closer to the cylinder central axis than that of the seat surface, occurrence of the unnecessary increase in volume that does not contribute to combustion at an opening section of the intake or exhaust port can be suppressed.

An engine according to a second aspect includes: the cylinder head and a cylinder block having an inner wall surface forming the combustion chamber along with the cylinder head.

According to this engine, with an inner diameter of the inner wall surface of the cylinder head that is not increased, occurrence of the unnecessary increase in volume that does not contribute to combustion at the opening section of the intake or exhaust port can be suppressed. Combustion efficiency can be improved while achieving compactness.

In the engine, the tapered surface is positioned inside the inner wall surface of the cylinder block if viewed in the cylinder central axis of the engine.

Thereby, occurrence of the unnecessary increase in volume that does not contribute to combustion in an inner space of the tapered surface at the opening section of the intake or exhaust port can be suppressed.

Thus, for described embodiments, since occurrence of the unnecessary increase in volume that does not contribute to combustion in the inner space of the tapered surface at the opening section of the intake or exhaust port can be suppressed, combustion efficiency can be improved.

### BRIEF DESCRIPTION OF DRAWINGS

FIG. 1 is a longitudinal sectional view of a gas engine according to an embodiment.

FIG. 2 is an enlarged view of an opening section of an intake port in the gas engine of FIG. 1.

FIG. 3 shows a cylinder head in the gas engine of FIG. 1 if viewed from a direction of a cylinder central axis.

FIG. 4 is a longitudinal sectional view of a conventional gas engine.

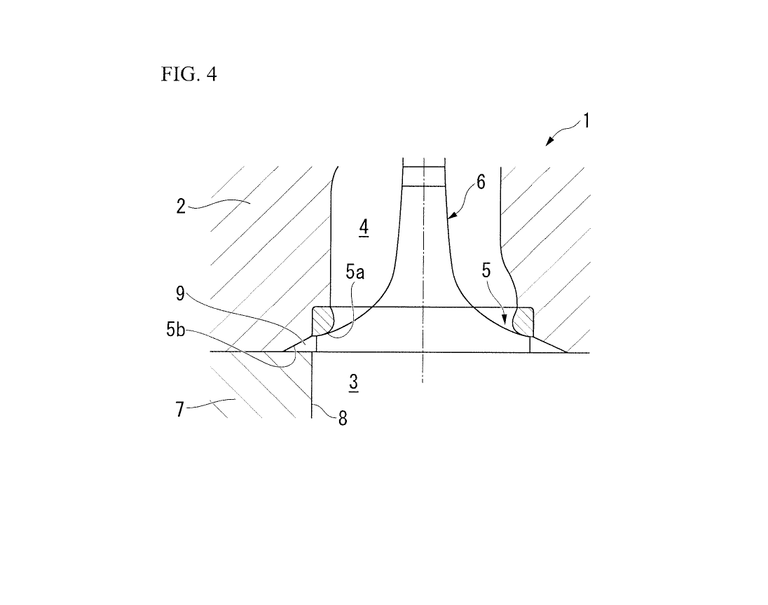

### DESCRIPTION

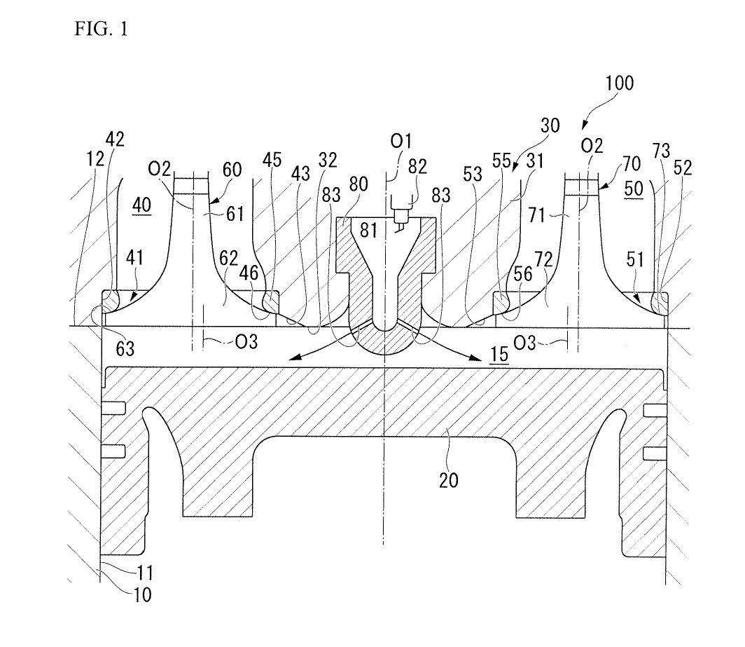

Hereinafter, a gas engine (engine) 100 of an embodiment will be described with reference to FIGS. 1 to 3.

As shown in FIG. 1, gas engine 100 is equipped with a cylinder block 10, a piston 20, a cylinder head 30, an antechamber cap 80, intake valves 60, and exhaust valves 70.

Cylinder block 10 is a tubular member extending in a direction of a cylinder central axis O1. An inner wall surface 11 of cylinder block 10 has a circular cross section perpendicular to cylinder central axis O1, and is shaped as a cylindrical surface whose inner diameter is uniform in the direction of cylinder central axis O1.

Piston 20 is configured to close the side of one end (lower side in FIG. 1) of cylinder block 10 and is disposed inside cylinder block 10. Piston 20 is disposed to enable reciprocation in the direction of cylinder central axis O1. Piston 20 is connected to one end of a connecting rod (not shown), and the other end of the connecting rod is connected to a crankshaft (not shown). Thereby, reciprocation of piston 20 is transmitted as rotational motion to the crankshaft via the connecting rod.

Cylinder head 30 is a member disposed at the other end (upper side in FIG. 1) of cylinder block 10. Cylinder head 30 has a cylinder head body 31 shaped as a lid closing the side of the other end of cylinder block 10. A surface of cylinder head body 31 which faces the side of cylinder block 10 becomes a roof surface 32 having a flat shape perpendicular to cylinder central axis O1. Roof surface 32 of cylinder head body 31 abuts an end face 12 of cylinder block 10. Thereby, cylinder head body 31 is integrally fixed to cylinder block 10.

Thus, a combustion chamber 15 is defined in cylinder block 10 by roof surface 32 of cylinder head body 31, inner wall surface 11 of cylinder block 10, and piston 20.

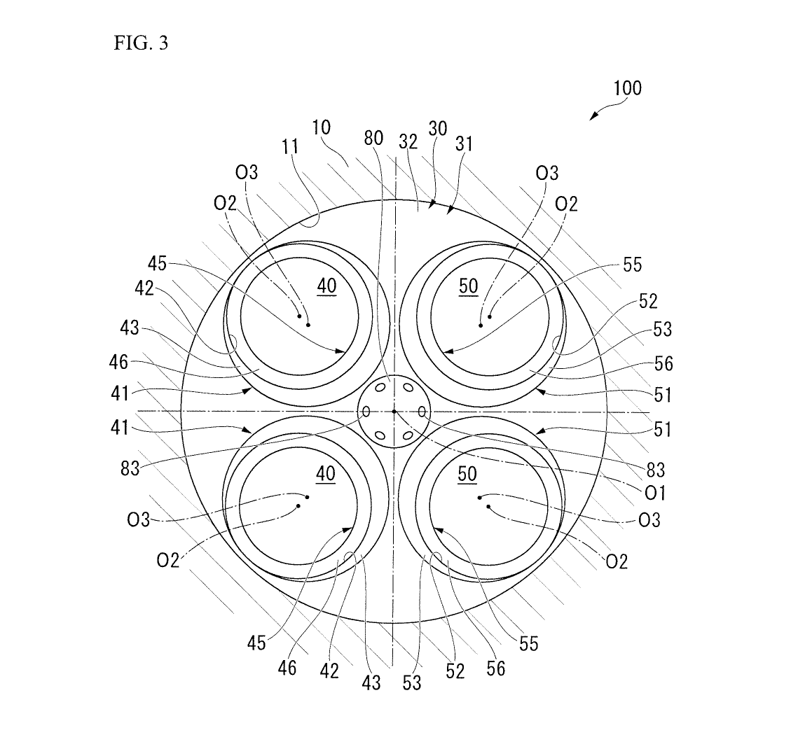

Roof surface 32 of cylinder head 30 is formed with intake ports 40 and exhaust ports 50, both of which are opened toward combustion chamber 15, so as to pass through cylinder head 30. In the present embodiment, as shown in FIG. 3, intake ports 40 and exhaust ports 50 are formed in a pair. Intake ports 40 and exhaust ports 50 are disposed at intervals in a circumferential direction around cylinder central axis O1. Pair of intake ports 40 is disposed to be adjacent to each other in the circumferential direction around cylinder central axis O1. Pair of exhaust polls 50 is also disposed to be adjacent to each other in the circumferential direction around cylinder central axis O1.

Ends (not shown) of intake ports 40 which are located at the side opposite to the side of combustion chamber 15 are connected to a gas mixture passage (not shown), and a gas mixture of air and a combustion gas is supplied to intake ports 40 via the gas mixture passage.

Ends (not shown) of exhaust ports 50 which are located at the side opposite to the side of combustion chamber 15 are connected to an exhaust gas passage (not shown), and an exhaust gas of the gas mixture provided for combustion in combustion chamber 15 is discharged outside via the exhaust gas passage.

Antechamber cap 80 is disposed to be buried in the center of roof surface 32 of cylinder head 30, and a part thereof protrudes inside combustion chamber 15. Antechamber cap 80 is formed centered on cylinder central axis O1, and a hollow portion inside thereof becomes an antechamber 81. Further, antechamber cap 80 is formed with a plurality of ejection holes 83 that allow antechamber 81 and combustion chamber 15 to communicate with each other.

An antechamber gas is supplied to antechamber 81 in antechamber cap 80 via an antechamber gas passage (not shown). Further, antechamber 81 is provided with a spark plug 82 that generates sparks. Antechamber gas in antechamber 81 is ignited by sparks of spark plug 82, and thereby generated flames are ejected into combustion chamber 15 via ejection holes 83.

Intake valves 60 and exhaust valves 70 are valves that reciprocate in directions of respective valve axes O2 and thereby open and close intake ports 40 and exhaust valves 70. Intake valves 60 are provided inside intake ports 40. Intake valves 60 are capable of closing intake ports 40. Exhaust valves 70 are provided inside exhaust ports 50. Exhaust valves 70 are capable of closing exhaust ports 50. In the present embodiment, valve axes O2 of intake valves 60 and exhaust valves 70 are located in intake ports 40 and exhaust ports 50, respectively. Valve axes O2 of intake valves 60 and exhaust valves 70 are parallel to cylinder central axis O1.

Intake valves 60 and exhaust valves 70 have valve stems 61 and 71 and valve faces 62 and 72 that are formed centered on respective valve axes O2. Valve stems 61 and 71 are rod-like members extending along valve axes O2. Valve stems 61 and 71 enable reciprocation along stem guides (not shown) formed in cylinder head 30 in the directions of axes O2. Also, valve faces 62 are integrally provided at the end of valve stems 61, located at one side in the direction of valve axis O2, that is, at the side of combustion chamber 15. Valve faces 72 are integrally provided at the end of valve stems 71, located at one side in the direction of valve axis O2, that is, at the side of combustion chamber 15. The outer circumferential surfaces of valve faces 62 and 72 are face surfaces 63 and 73, which gradually increase in diameter toward the one side in the direction of valve axis O2.

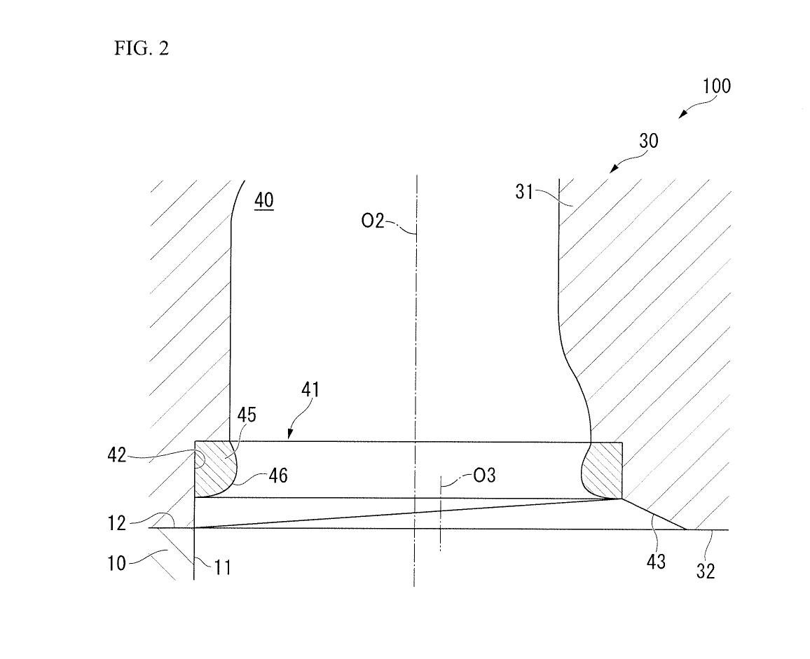

Here, opening sections 41 and 51 of intake valve 60 and exhaust valve 70, which face combustion chamber 15, are formed with seat surfaces 46 and 56 and tapered surfaces 43 and 53, respectively. An enlarged view of opening section 41 of intake port 40 is shown in FIG. 2; exhaust port 50 also has the same constitution.

Seat surfaces 46 and 56 are surfaces on which face surfaces 63 and 73 of intake and exhaust valves 60 and 70 abut throughout the circumferential areas around valve axes O2. Seat surfaces 46 and 56 of the present embodiment are formed on valve seats 45 and 55 fitted into opening sections 41 and 51.

That is, opening sections 41 and 51 of intake port 40 and exhaust port 50 are formed with cylindrical surfaces 42 and 52, in which a cross-sectional shape perpendicular to valve axis O2 is circularly centered on valve axis O2, and which extend with the same inner diameter in the direction of valve axis O2. Thus, valve seats 45 and 55 shaped as a ring are configured to be fitted onto cylindrical surfaces 42 and 52 and are integrally fixed to cylindrical surfaces 42 and 52. Thereby, inner circumferential surfaces of valve seats 45 and 55 become seat surfaces 46 and 56, which are gradually increased in diameter toward the one side in the direction of valve axis O2 so as to be curved.

Face surfaces 63 and 73 of intake and exhaust valves 60 and 70 come into contact with seat surfaces 46 and 56 at the side of combustion chamber 15, i.e. at the one side in the direction of valve axis O2, throughout the circumferential area. In this way, in the state in which face surfaces 63 and 73 and seat surfaces 46 and 56 come into contact with each other, the inside of the combustion chamber 15 and the inside of intake port 40 are separated from each other by intake valve 60, and the inside of combustion chamber 15 and the inside of exhaust port 50 are separated from each other by exhaust valve 70. That is, face surfaces 63 and 73 come into contact with seat surfaces 46 and 56 of intake and exhaust ports 40 and 50, and thereby intake port 40 and exhaust port 50 are in a closed state.

On the other hand, if intake valve 60 and exhaust valve 70 are separated to the one side in the direction of valve axis O2 in this state, the inside of combustion chamber 15 and the inside of intake port 40, and the inside of the combustion chamber 15 and the inside of exhaust port 50 communicate with each other via a gap between intake valve 60 and seat surface 46 and a gap between exhaust valve 70 and seat surface 56. That is, face surfaces 63 and 73 are separated from seat surfaces 46 and 56 of intake and exhaust ports 40 and 50, and thereby intake port 40 and exhaust port 50 are in an open state.

Tapered surfaces 43 and 53 are formed closer to combustion chamber 15 than face surfaces 63 and 73, and have a tapered shape in which they gradually increase in diameter toward combustion chamber 15. Central axes O3 of tapered surfaces 43 and 53 are disposed eccentrically from valve axes O2 toward cylinder central axis O1. That is, central axes O3 of tapered surfaces 43 and 53 are located closer to cylinder central axis O1 than valve axes O2.

As shown in FIG. 3, maximum inner diameters of tapered surfaces 43 and 53, i.e. inner diameters of intersecting ridgelines between tapered surface 43 and roof surface 32 and between tapered surface 53 and roof surface 32, are set to be greater than those of cylindrical surfaces 42 and 52. Also, open edges of tapered surfaces 43 and 53 which are the intersecting ridgelines have inner diameters in such a manner that portions at the side most separated from cylinder central axis O1 (i.e., ends at a radial outer side of cylinder central axis O1) abut cylindrical surfaces 42 and 52 if viewed from the direction of cylinder central axis O1.

Further, if viewed from the direction of cylinder central axis O1, tapered surfaces 43 and 53 are disposed to be present at a radial inner side of inner wall surface 11 of cylinder block 10.

Such tapered surfaces 43 and 53 can be easily formed by fixing cutting tools above axes becoming central axes O3 of tapered surfaces 43 and 53, i.e. axes offset from valve axes O2 toward cylinder central axis O1, and spinning the cutting tools.

Next, operations of gas engine 100 and cylinder head 30 that have the aforementioned constitutions will be described.

During operation of gas engine 100, intake ports 40 are in an open state during an intake stroke, and thereby a gas mixture is introduced into combustion chamber 15. Next, in a compression process, intake ports 40 are closed by intake valve 60, and piston 20 moves toward cylinder head 30. Thereby, the gas mixture of combustion chamber 15 is compressed. Afterwards, in a combustion stroke, an antechamber gas in antechamber 81 is ignited, and the resultant flames are ejected into combustion chamber 15 via ejection holes 83. Thereby, the gas mixture of combustion chamber 15 is combusted. Thus, as a result of combustion of the gas mixture, piston 20 is pressed toward the side separated from cylinder head 30. Then, in an exhaust stroke, exhaust ports 50 are in an open state, and an exhaust gas of combustion chamber 15 is discharged outside gas engine 100.

The intake stroke, the compression stroke, the combustion stroke, and the exhaust stroke are repeatedly performed, and thereby reciprocation of piston 20 is continuously performed.

According to gas engine 100 equipped with the aforementioned cylinder head 30, since central axes O3 of tapered surfaces 43 and 53 of opening sections 41 and 51 of intake and exhaust ports 40 and 50 are disposed eccentrically from valve axes O2 toward cylinder central axis O1, occurrence of the unnecessary increase in volume that does not contribute to combustion in gas engine 100 can be suppressed.

That is, for example, if the open edges of tapered surfaces 43 and 53 are partly protruded to a radial outer side relative to inner wall surface 11 of cylinder block 10, a space is formed between tapered surface 43 and end face 12 of cylinder block 10 and between tapered surface 53 and end face 12 of cylinder block 10. If intake valves 60 and exhaust valves 70 are closed, such spaces are isolated from a combustion space by intake valve 60 and exhaust valve 70. Accordingly, even if a gas mixture is present in the isolated spaces, the gas mixture is not used for combustion.

In contrast, in the present embodiment, since tapered surfaces 43 and 53 can be inhibited from protruding to the radial outer side relative to inner wall surface 11 of cylinder block 10 due to eccentricity of central axes O3 of tapered surfaces 43 and 53, volumes of the spaces isolated from combustion chamber 15 can be reduced by intake valve 60 and exhaust valve 70 during the combustion stroke.

Thereby, the volumes of the spaces that do not contribute to combustion, i.e., the spaces in which a gas mixture is not ignited despite its presence, can be minimized. Thus, it is possible to avoid reducing combustion efficiency.

Here, it is thought that, if the inner diameter of inner wall surface 11 of cylinder block 10 is increased, occurrence of the unnecessary increase in volume that does not contribute to combustion can be suppressed, even if tapered surfaces 43 and 53 are not disposed eccentrically. However, in this case, enlargement of combustion chamber 15 results in an increase of the size of gas engine 100, and the result thereof is not preferable.

In the present embodiment, central axes O3 of tapered surfaces 43 and 53 are disposed eccentrically toward cylinder central axis O1, and thereby the unnecessary volume can be reduced although the inner diameter of inner wall surface 11 of cylinder block 10 is not increased. Accordingly, combustion efficiency can be improved while maintaining compactness of gas engine 100.

Further, as in the present embodiment, tapered surfaces 43 and 53 are disposed at the radial inner side of inner wall surface 11 of cylinder block 10. Thereby, occurrence of the unnecessary increase in volume can be reliably prevented. Thereby, the entire gas mixture in the combustion space can contribute to combustion, and combustion efficiency can be maximized.

Although a preferred embodiment of the present invention has been described, the present invention is not limited thereto, and can be appropriately modified without departing from the technical spirit of the present invention.

For example, in the present embodiment, tapered surfaces 43 and 53 of opening sections 41 and 51 of intake and exhaust ports 40 and 50 are offset toward cylinder central axis O1. However, any one of central axes O3 of tapered surfaces 43 and 53 of the intake and exhaust ports 40 and 50 may be disposed eccentrically, instead. Even according to this constitution, in this case, unnecessary volume that does not contribute to combustion can be reduced.

Further, in the embodiment, the example in which seat surfaces 46 and 56 of the valve seats 45 and 55 are formed has been described. However, seat surfaces 46 and 56 may be directly formed on inner wall surfaces 11 of intake and exhaust ports 40 and 50.

In addition, in the embodiment, the example in which the present invention is applied to gas engine 100 equipped with antechamber 81 has been described. However, the present invention may be applied to a gas engine 100 that is not equipped with antechamber 81, or engines such as a gasoline engine other than the gas engine 100.

What is claimed is:

1. A cylinder head comprising:
a cylinder head body provided with intake and exhaust ports opened toward a combustion chamber and capable of being closed by valves, the intake and exhaust ports being separated from each other in a circumferential direction around a cylinder central axis;
an antechamber cap disposed in a center of the cylinder head body and provided with ejection holes through which flames are to be ejected, the flames to result from ignition of an antechamber gas to be supplied to an inner hollow portion of the antechamber cap;
wherein an opening section of at least one of the intake or exhaust ports facing the combustion chamber is provided with a seat surface centered on a valve axis and a tapered surface disposed closer to the combustion chamber than the seat surface, the tapered surface gradually increasing in diameter closer to the combustion chamber; and
a central axis of the tapered surface is disposed eccentrically from the valve axis toward the cylinder central axis.

2. An engine comprising:
the cylinder head according to claim 1; and
a cylinder block having an inner wall surface forming the combustion chamber along with the cylinder head.

3. The engine according to claim 2, wherein
the tapered surface is positioned inside the inner wall surface of the cylinder block if viewed in the cylinder central axis of the engine.
